(19) United States
(12) Patent Application Publication
(10) Pub. No.: US 2010/0289993 A1
(43) Pub. Date: Nov. 18, 2010

(54) COLOR FILTER MANUFACTURING METHOD, COLOR FILTER, AND DISPLAY DEVICE PROVIDED WITH SAME

(75) Inventor: Ryotaro MATSUYAMA, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/778,377

(22) Filed: May 12, 2010

(30) Foreign Application Priority Data
May 14, 2009 (JP) 2009-117294

(51) Int. Cl. G02F 1/1335; B41J 2/145

(52) U.S. Cl. 349/106; 347/40

(57) ABSTRACT

A method for manufacturing a color filter includes forming a bank on a substrate to partition the substrate into a plurality of drawing regions, and forming color filter layers in the drawing regions by selectively moving a droplet ejection head having nozzles in first and second scanning directions relative to the substrate and selectively ejecting a liquid from the nozzles into each of the drawing regions. The substrate is partitioned into the drawing regions including a plurality of ejection regions, into which the liquid is ejected. The ejection regions are arranged with a first prescribed pitch in the first scanning direction equal to an integer multiple of a pitch of the nozzles in the first scanning direction. The liquid is ejected from the same set of the nozzles before and after the droplet ejection head is moved relative to the substrate in the first scanning direction.

### CROSS-REFERENCE TO RELATED APPLICATIONS

This application claims priority to Japanese Patent Application No. 2009-117294 filed on May 14, 2009. The entire disclosure of Japanese Patent Application No. 2009-117294 is hereby incorporated herein by reference.

### BACKGROUND

1. Technical Field

The present invention relates to a color filter manufacturing method, a color filter, and a display device that is provided with the color filter.

2. Related Art

Methods have recently been proposed for forming color filters using an inkjet system in which ink is ejected by a droplet ejection head (see Japanese Laid-Open Patent Publication No. 2006-204973, for example). In this type of manufacturing method, a liquid (liquid droplets) including a color material is ejected from a plurality of nozzles provided to a droplet ejection head that moves relative to a substrate to arrange (draw) the liquid, and the arranged liquid is then cured by drying or the like to form colored films that correspond to pixels.

The substrate is partitioned into a matrix having a plurality of regions by a bank formed on the substrate. The droplet ejection head is moved relative to the substrate in a primary scanning direction and a secondary scanning direction, and thereby ejects the liquid into the partitioned regions. During this operation, since the liquid is not ejected when the nozzles are positioned over the bank, not all of the nozzles eject the liquid at the same time. The plurality of nozzles thus includes nozzles that eject liquid and nozzles that do not eject liquid. The distribution (ejection pattern) of nozzles that eject liquid among the plurality of nozzles must therefore change each time the droplet ejection head is moved in the secondary scanning direction.

### SUMMARY

However, the drawbacks described below remain to be overcome in the conventional color filter manufacturing method described above. Specifically, when the ejection pattern is changed with each scan, the ejected amount of liquid fluctuates even when the liquid is ejected from the corresponding nozzles using the same drive signal regardless of the ejection pattern. The ejected amount of liquid therefore fluctuates according to the ejection pattern.

The present invention was developed in view of the foregoing drawbacks, and an object of the present invention is to provide a color filter manufacturing method whereby fluctuation in the ejected amount of liquid is suppressed, to provide a color filter, and to provide a display device provided with the color filter.

The present invention is configured as described below in order to overcome the foregoing drawbacks. A method for manufacturing a color filter according to the first aspect includes forming a bank on a substrate to partition the substrate into a plurality of drawing regions, and forming color filter layers in the drawing regions by selectively moving a droplet ejection head having a plurality of nozzles in a first scanning direction and a second scanning direction relative to the substrate and selectively ejecting a liquid from the nozzles into each of the drawing regions. The forming of the bank includes partitioning the substrate into the drawing regions including a plurality of ejection regions, into which the liquid is ejected from the nozzles, with the ejection regions being arranged with a first prescribed pitch in the first scanning direction that is equal to an integer multiple of a pitch of the nozzles in the first scanning direction. The forming of the color filter layers includes ejecting the liquid from the same set of the nozzles before and after the droplet ejection head is moved relative to the substrate in the first scanning direction.

A color filter according to the second aspect includes a bank formed on a substrate and partitioning a plurality of drawing regions on the substrate, and color filter layers formed by ejecting a liquid from a plurality of nozzles arranged in a row in a droplet ejection head into the drawing regions. The drawing regions includes a plurality of ejection regions, into which the liquid is ejected, with the ejection regions being arranged with a first prescribed pitch in a first direction that is equal to an integer multiple of a pitch of the nozzles in the first direction.

In the above aspects, since the liquid is ejected into each ejection region without changing the ejection pattern, which is the distribution of ejecting nozzles and non-ejecting nozzles among the plurality of nozzles, fluctuation of the ejected amount of liquid in each drawing region can be suppressed.

Specifically, the pitch of the ejection regions in the first scanning direction (first direction) is set to an integer multiple of the pitch of the nozzles, and when the droplet ejection head is moved relative to the substrate in the first scanning direction (first direction) an amount commensurate with an integer multiple of the pitch of the ejection regions, the nozzles positioned over an ejection region prior to movement are thus positioned over the ejection region after movement as well. Nozzles not positioned over the ejection region prior to movement are also not positioned over the ejection region after movement. There is therefore no change in the pattern of ejection by the plurality of nozzles from before to after the droplet ejection head is moved relative to the substrate in the first scanning direction (first direction). Structural crosstalk in the droplet ejection head is thus reduced, and the amount of liquid ejected from the droplet ejection head is stabilized.

Fluctuation of the ejected amount of liquid is thereby suppressed, and the thickness of the color filter layer can be made more uniform.

Preferably, in the method for manufacturing a color filter according to the first aspect, the forming of the bank includes partitioning the substrate into the drawing regions including a plurality of adjustment regions that adjust a pitch of the drawing regions in the first scanning direction to a second prescribed pitch that is equal to an integer multiple of a pitch in the first scanning direction of pixel regions of a display device in which the color filter is used, each of the drawing regions being formed by at least one of the adjustment regions and at least one of the ejection regions that are connected together.

Preferably, in the color filter of the second aspect, the drawing regions include a plurality of adjustment regions that adjust a pitch of the drawing regions in the first direction to a second prescribed pitch, each of the drawing regions being formed by at least one of the adjustment regions and at least one of the ejection regions that are connected together.

In the present invention, providing the adjustment regions so as to be connected to the ejection regions makes it possible to coordinate the pitch of the drawing regions overall to the pitch of the pixel regions.

Preferably, in the method for manufacturing a color filter according to the first aspect, the forming of the bank includes forming the bank with light-blocking material.

In the present invention, when the color filter is incorporated into a display device, light can be prevented from leaking through the bank from the pixel regions of the display device, and the contrast and other image quality aspects of the display device can be enhanced.

A display device according to the third aspect includes the color filter described above.

In the present invention, providing a color filter having a color filter layer with a more uniform thickness enhances the image quality of the display device.

### BRIEF DESCRIPTION OF THE DRAWINGS

Referring now to the attached drawings which form a part of this original disclosure:

FIG. 1 is a schematic plan view showing the color filter according to an embodiment of the present invention;

FIG. 2 is a perspective view showing the droplet ejection apparatus;

FIG. 3 is a view showing the structure of the droplet ejection head;

FIG. 4 is a schematic plan view showing the color filter manufacturing process;

FIG. 5 is a view showing the color filter manufacturing process;

FIG. 6 is a schematic plan view showing an organic EL device provided with the color filter;

FIG. 7 is an equivalent circuit diagram showing the organic EL device;

FIG. 8 is a partial sectional view of FIG. 6; and

FIG. 9 is a schematic plan view showing another color filter to which the present invention can be applied.

### DETAILED DESCRIPTION OF EXEMPLARY EMBODIMENTS

An embodiment of the color filter and color filter manufacturing method of the present invention will be described hereinafter with reference to the drawings. The scale of the drawings used in the following description is adjusted as needed to make each member large enough to recognize.

### Color Filter

The color filter of the present embodiment will first be described.

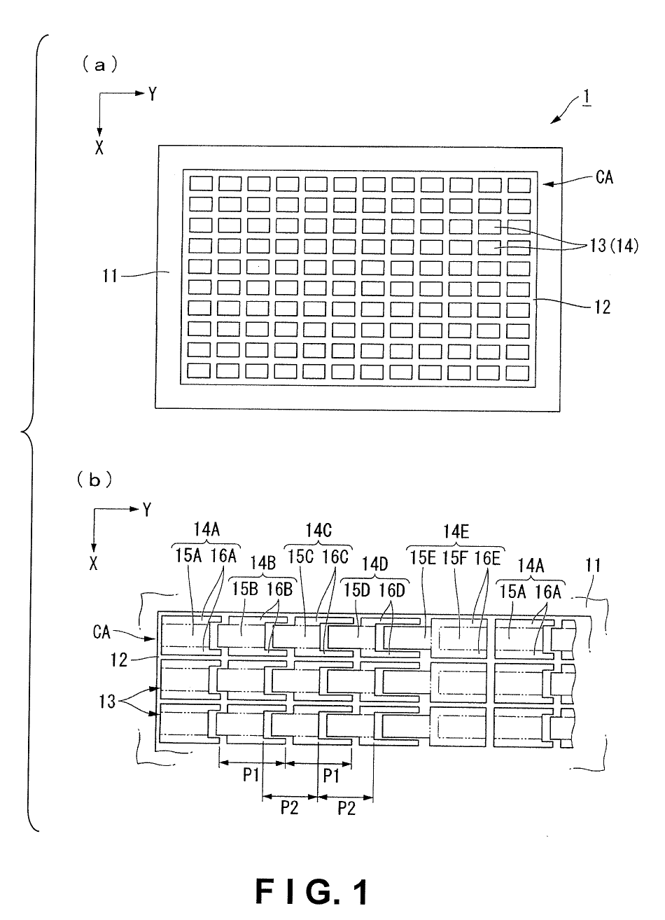

The color filter 1 is provided with a substrate 11, a bank 12 formed on the substrate 11, and color filter layers 13 formed in regions partitioned by the bank 12, as shown in a simplified view of FIGS. 1(a) and a detailed view of FIG. 1(b). In the color filter 1, a panel region CA is formed by the bank 12 and the color filter layers 13.

The substrate 11 is formed using glass or another translucent material, for example, and is substantially rectangular as viewed in a plane.

The bank 12 is formed using a resin material or other light-blocking material such as acrylic resin that is colored black or another color, for example. As shown in FIG. 1(b), the bank 12 is formed in the shape of a frame having substantially rectangular openings on the substrate 11, and drawing regions 14A through 14E (also referred to collectively as drawing regions 14) that are concave regions surrounded by the bank 12 are thereby partitioned from each other.

A plurality of drawing regions 14 is arranged in a matrix in the mutually orthogonal X direction (second scanning direction) and Y direction (first scanning direction) of the substrate 11, and the drawing regions 14 are formed so as to correspond to pixel regions 110 of an organic EL device (display device) 100 described hereinafter that is provided with the color filter 1 of the present embodiment. The drawing regions 14A through 14E are arranged in a repeating sequence of drawing regions 14A through 14E in the Y direction.

The pitch P1 (second prescribed pitch) in the Y direction of the drawing regions 14A through 14D, i.e., the distance between the end portions on the +Y direction side (right side in FIG. 1(b)) of two drawing regions 14 adjacent to each other in the Y direction, is equal to the pitch of the pixel regions 110. The pitch P1 in the Y direction of the drawing regions 14E is twice the pitch of the pixel regions 110. The width in the X direction of the drawing regions 14A through 14E is equal to the width of the pixel regions 110.

The drawing regions 14 have ejection regions 15A through 15F (also referred to collectively as ejection regions 15), and adjustment regions 16A through 16E (sometimes referred to collectively as adjustment regions 16) that are connected to the ejection regions 15. The drawing regions 14E furthest in the +Y direction among the drawing regions 14A through 14E have two ejection regions 15E, 15F that are connected to each other.

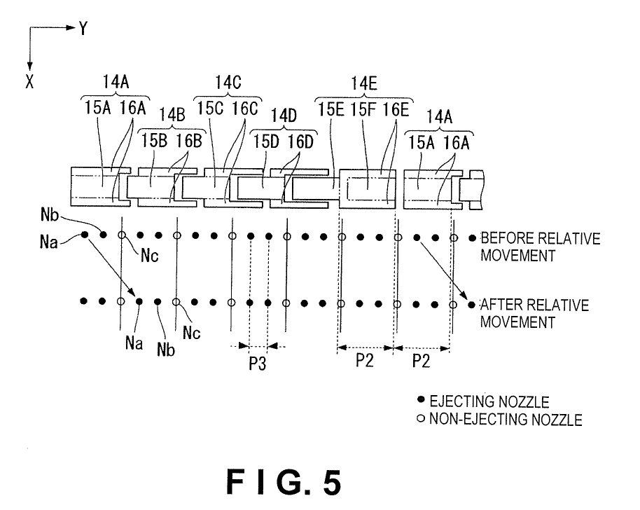

The ejection regions 15A through 15F are substantially rectangular as viewed in a plane, and are formed as a sequence of ejection regions 15A through 15F in the Y direction. As shown in FIG. 5, the pitch P2 (first prescribed pitch) in the Y direction of the ejection regions 15, i.e., the distance between the end portions on the +Y direction side of two ejection regions 15 adjacent to each other in the Y direction, is three times the pitch P3 in the secondary scanning direction of the nozzles N described hereinafter. The pitch P2 in the Y direction of the ejection regions 15 is equal to ⅚ the pitch P1 in the Y direction of the drawing regions 14.

The adjustment regions 16 are formed on both sides in the X direction of the drawing regions 14, and the adjustment regions 16 adjust the pitch in the Y direction of the drawing regions 14. The adjustment regions 16 are in the shape of bands having a narrower width than the ejection regions 15 in the X direction, and extend in the X direction. The width of the adjustment regions 16 in the Y direction is equal to the width of the pixel regions 110.

The ends of the adjustment regions 16A on the −Y direction side (left side in FIG. 1(b)) coincide with the ends of the ejection regions 15A on the −Y direction side, and protrude past the ends of the ejection regions 15A on the +Y direction side. The ends of the ejection regions 15B on the −Y direction side are positioned between the adjustment regions 16A arranged at a distance from each other in the X direction.

Each of the adjustment regions 16B through 16D extends from the +Y direction side past the ends on the −Y direction side of the corresponding ejection regions 15B through 15D, and protrudes from the ends of the ejection regions 15B through 15D on the +Y direction side. The ends on the −Y direction side of the ejection regions 15C through 15E adjacent to each other in the +Y direction are positioned between the adjustment regions 16B through 16D that are arranged at a distance from each other in the X direction.

The adjustment regions 16E extend from the ends of the ejection regions 15E on the +Y direction side, and the ends on the +Y direction side coincide with the ends of the ejection regions 15F on the +Y direction side.

The color filter layers 13 are formed using acrylic resin, for example, and include color materials that correspond to each display color of the drawing regions 14. The color filter layers 13 are arranged with same colors in the Y direction, and in the repeated color sequence R (red), G (green), B (blue) in the X direction. Specifically, the color filter layers 13 are arranged in stripes with color filter layers 13 of the same color arranged in straight lines in one direction (Y direction) being arranged in alternating fashion in the other direction (X direction).

### Color Filter Manufacturing Method

The method for manufacturing the color filter 1 configured as described above will next be described.

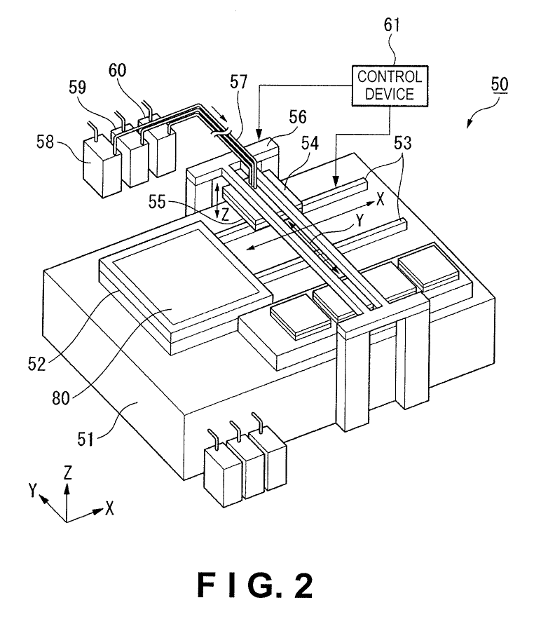

The color filter 1 is manufactured using a droplet ejection apparatus 50 such as the one shown in FIG. 2.

The droplet ejection apparatus 50 is an apparatus for forming the color filter layers 13 by ejecting a liquid onto predetermined regions of a mother substrate 80 described hereinafter through the use of an inkjet system, for example. The droplet ejection apparatus 50 is provided with a mounting base 51, a workpiece stage 52, a stage movement device 53, a carriage 54, droplet ejection heads 55, a carriage movement device 56, tubes 57, first through third tanks 58 through 60, and a control device 61.

The mounting base 51 is a support base for the workpiece stage 52 and the stage movement device 53. The workpiece stage 52 is provided on the mounting base 51 so as to be able to be moved in the X direction as the primary scanning direction by the stage movement device 53, and the mother substrate 80 transported from a transport device (not shown) on the upstream side is retained in the XY plane by a suction attachment mechanism.

The stage movement device 53 is provided with a linear guide, a ball screw, and other direct-acting mechanisms, and the stage movement device 53 moves the workpiece stage 52 in the X direction on the basis of a stage position control signal inputted from the control device to indicate the X coordinate of the movement destination of the workpiece stage 52.

The carriage 54 holds the droplet ejection heads 55, and is provided so as to be able to be moved in the Z direction and the Y direction, which is the secondary scanning direction, by the carriage movement device 56.

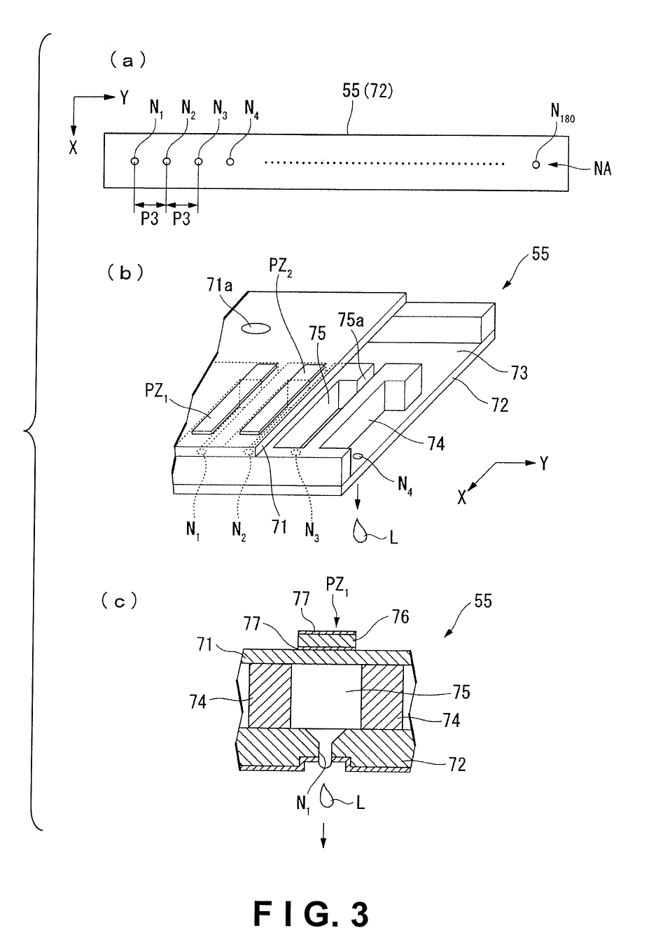

As shown in FIGS. 3(a) and 3(b), the droplet ejection heads 55 are provided with a plurality of nozzles N, and as shown in FIG. 2, the droplet ejection heads 55 eject liquid on the basis of image data or drive signals inputted from the control device 61. A droplet ejection head 55 is provided corresponding to the R (red), G (green), and B (blue) liquid, and each is connected to a tube 57 via the carriage 54.

Liquid used for R (red) is fed from a first tank 58 via a tube 57 to the droplet ejection head 55 that corresponds to R (red), liquid used for G (green) is fed from a second tank 59 via a tube 57 to the droplet ejection head 55 that corresponds to G (green), and liquid used for B (blue) is fed from a third tank 60 via a tube 57 to the droplet ejection head 55 that corresponds to B (blue).

The carriage movement device 56 forms a bridge structure that straddles the mounting base 51, and is provided with a linear guide, a ball screw, and other direct-acting mechanisms along the Y direction and Z direction, and moves the carriage 54 in the Y direction and Z direction on the basis of a carriage position control signal inputted from the control device 61 to indicate the Y coordinate and Z coordinate of the movement destination of the carriage 54.

The tubes 57 are liquid feeding tubes connecting the first through third tanks 58 through 60 with the carriage 54.

The first tank 58 stores the liquid used for R (red) and feeds the liquid to the droplet ejection head 55 that corresponds to R (red) via the tube 57. The second tank 59 stores the liquid used for G (green) and feeds the liquid to the droplet ejection head 55 that corresponds to G (green) via the tube 57. The third tank 60 the liquid used for B (blue) and feeds the liquid to the droplet ejection head 55 that corresponds to B (blue) via the tube 57.

The control device 61 is a device for controlling the operation for positioning the mother substrate 80 by movement of the workpiece stage 52; the operation for positioning the droplet ejection head 55 by movement of the carriage 54; and the droplet ejection operation by the droplet ejection heads 55 for ejecting the liquid in predetermined positions on the mother substrate 80. The control device 61 outputs the stage position control signal to the stage movement device 53, outputs the carriage position control signal to the carriage movement device 56, and outputs image data and a drive signal to the droplet ejection heads 55.

The structure of the droplet ejection heads 55 will next be described.

The droplet ejection head 55 as shown in FIG. 3(a) is provided with a plurality of (180, for example) nozzles N₁ through N₁₈₀ (also referred to collectively as nozzles N) arranged in the Y direction. The plurality of nozzles N is arranged at equal intervals at the pitch P3. A nozzle row NA is formed by the nozzles N₁ through N₁₈₀.

The droplet ejection head 55 is provided with only one nozzle row NA, but may be provided with a plurality of rows, and the number of nozzles N constituting the nozzle row NA is not limited to 180. However, when a plurality of nozzle rows NA is provided, the Y-direction offset at which the nozzles N are formed is an integer multiple of the pitch P3 in nozzle rows NA that are adjacent in the X direction. The number of droplet ejection heads 55 provided in the carriage 54 may also be changed to any number. A plurality of carriages 54 may also be provided as sub-carriage units.

As shown in FIGS. 3(b) and 3(c), the droplet ejection head 55 is provided with a vibration plate 71 to which a material feeding hole 71a connected to the tube 57 is provided; a nozzle plate 72 to which the nozzles N₁ through N₁₈₀ are provided; a reservoir 73 provided between the vibration plate 71 and the nozzle plate 72; a plurality of barriers 74; and a plurality of liquid holding portions 75.

Drive elements PZ₁ through PZ_{N} (also referred to collectively as drive elements PZ) are provided corresponding to each of the nozzles N₁ through N₁₈₀ on the vibration plate 71. The drive elements PZ are piezo elements, for example.

The reservoir 73 is filled with the liquid fed via the material feeding hole 71a.

The liquid holding portions 75 are formed by the surrounding vibration plate 71, nozzle plate 72, and pairs of barriers 74. The liquid holding portions 75 are formed so that one liquid holding portion 75 corresponds to each of the nozzles N₁ through N₁₈₀. The liquid from the reservoir 73 is introduced to the liquid holding portions 75 via feed openings 75a provided between the pairs of barriers 74.

As shown in FIG. 3(c), the drive elements PZ are provided with a piezoelectric material 76 and a pair of electrodes 77 between which the piezoelectric material is held. The drive element PZ causes the piezoelectric material 76 to contract when a drive signal is applied across the pair of electrodes 77, and the contraction of the piezoelectric material 76 causes the vibration plate 71 to flex outward (in the opposite direction from the liquid holding portion 75) together with the drive element PZ, thus increasing the volume of the liquid holding portion 75.

Consequently, an amount of liquid that corresponds to the increase in the volume of the liquid holding portion 75 flows in from the reservoir 73 via the feed opening 75a. When application of the drive signal to the drive element PZ is stopped in this state, the drive element PZ and the vibration plate 71 return to the original shapes thereof, and the liquid holding portion 75 also returns to the original volume thereof. The pressure of the liquid inside the liquid holding portion 75 is thereby increased, and a liquid droplet L is ejected toward the mother substrate 80 from the nozzle N₁.

The method for manufacturing the color filter 1 will next be described.

In the present embodiment, the color filter 1 is formed at once by forming a plurality of panel regions CA on a mother substrate 80 having a large surface area formed using glass or another translucent material, and then dividing the mother substrate 80 between each panel region CA. The plurality of panel regions CA is formed in a matrix in the X direction and Y direction.

The bank formation step of forming the bank 12 on the mother substrate 80 will first be described. The bank 12 in this case is formed on the mother substrate 80 using a photolithography technique or other technique.

The ejection step is then performed for forming the color filter layers 13 using the droplet ejection apparatus 50 described above in the drawing regions 14 partitioned by the bank 12.

First, the mother substrate 80 is mounted on the workpiece stage 52 so that the droplet ejection head 55 and the top surface of the mother substrate 80 are facing each other. The repetition pattern of the drawing regions 14A through 14E formed in the panel region CA of the mother substrate 80 is thereby aligned with the secondary scanning direction.

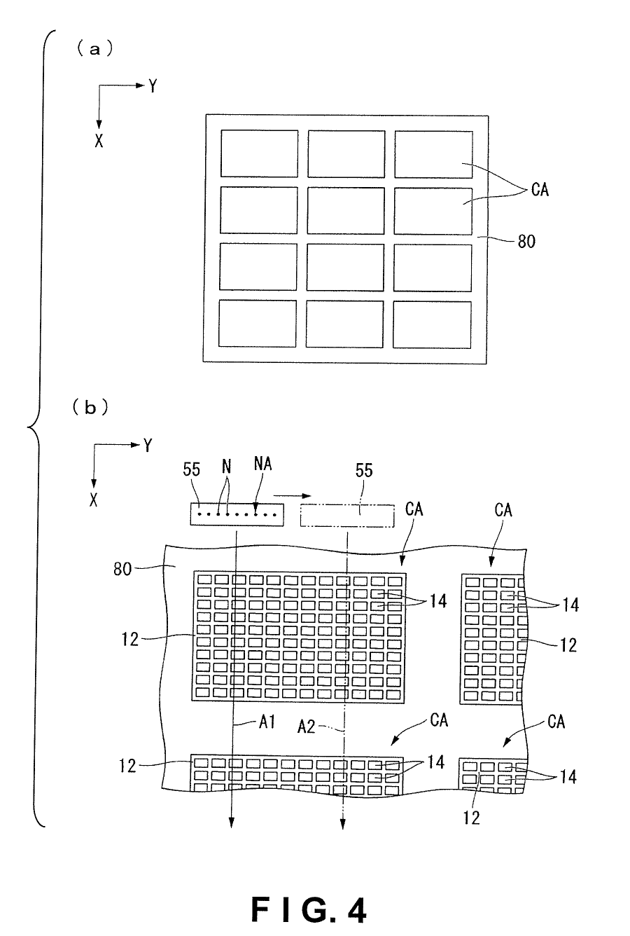

The liquid is then ejected toward the ejection regions 15 of the drawing regions 14 from the plurality of nozzles N of the droplet ejection head 55 while the stage movement device 53 and the carriage movement device 56 are moved relative to the mother substrate 80. The droplet ejection head 55 at this time is relatively moved a predetermined distance in the Y direction, which is the secondary scanning direction, after being moved relative to the mother substrate 80 in the direction of the arrow A1, which is the primary scanning direction, shown in FIG. 4(b), and the droplet ejection head 55 is again relatively moved in the direction of the arrow A2, which is the primary scanning direction. By repeating this operation, once the droplet ejection head 55 has moved from the left end to the right end of a single panel region CA, the droplet ejection head 55 returns to the left end of the panel region CA and scans along the Y direction, which is the primary scanning direction, in a position slightly different from the position of the previous ejection. By performing such scanning a plurality of times, the liquid is ejected to all of the drawing regions 14 in the panel region CA.

Since the drawing regions 14 are arranged in a matrix in the panel region CA, not all of the nozzles N in the droplet ejection head 55 eject liquid at the same time. The plurality of nozzles N therefore includes nozzles N (ejecting nozzles) that are positioned over the ejection regions 15 and eject liquid, and nozzles N (non-ejecting nozzles) that are not positioned over the ejection regions 15 and do not eject liquid.

In the present embodiment, the pitch P2 of the ejection regions 15 is three times the pitch P3 of the nozzles N. Therefore, two ejecting nozzles N and one non-ejecting nozzle N are arranged in alternating fashion in the plurality of nozzles N, as shown in FIG. 5. In this arrangement, the nozzles Na, Nb are positioned over the ejection region 15A, and are therefore ejecting nozzles, and the nozzles Nc are non-ejecting nozzles.

When the droplet ejection head 55 moves in relative fashion in the Y direction as the secondary scanning direction a distance commensurate with the pitch P2 of the ejection regions 15 as described above, the nozzles Na, Nb are positioned over the ejection region 15B, and therefore continue to be liquid-ejecting nozzles, and the nozzles Nc are not positioned over the ejection regions 15, and therefore continue to be non-ejecting nozzles. This same condition applies to the other nozzles N. Specifically, the nozzles N positioned over the ejection regions 15 prior to relative movement in the Y direction are positioned over the adjacent ejection regions 15 after relative movement in the Y direction as well, and nozzles N not positioned over the ejection regions 15 prior to relative movement are also not positioned over the ejection regions 15 after relative movement.

Consequently, there is no change in the ejection pattern of the plurality of nozzles N of the droplet ejection head 55 from before to after relative movement of the droplet ejection head 55 in the secondary scanning direction.

Since the ejection pattern of the droplet ejection head 55 is not changed, feeding the same drive signal to the nozzles N does not change the quantity of droplets ejected from the nozzles N that are positioned over the ejection regions 15.

The liquid landed in the ejection regions 15 spreads throughout the drawing regions 14. Color filter layers 13 having the desired thickness are formed by drying the liquid.

The mother substrate 80 is then divided by each panel region CA to manufacture the color filter 1.

### Organic EL Device

The organic EL device (display device) 100 provided with the color filter 1 of the present embodiment will next be described.

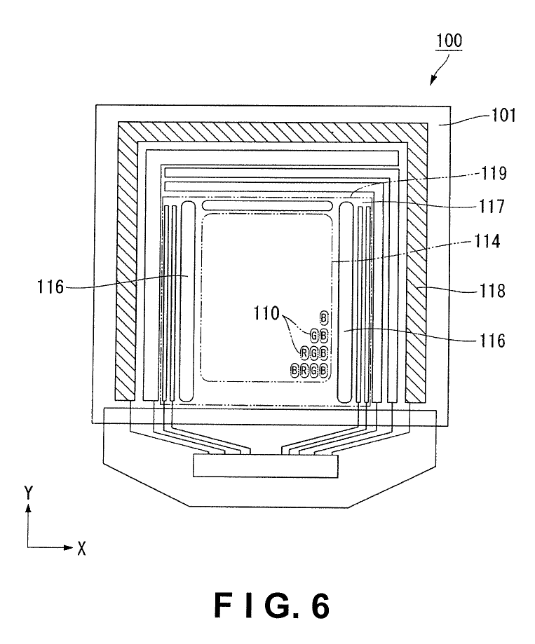

The organic EL device 100 of the present embodiment is an active-matrix-type color organic EL device, and is provided with an element substrate 101 that is substantially rectangular as viewed in a plane, as shown in FIG. 6.

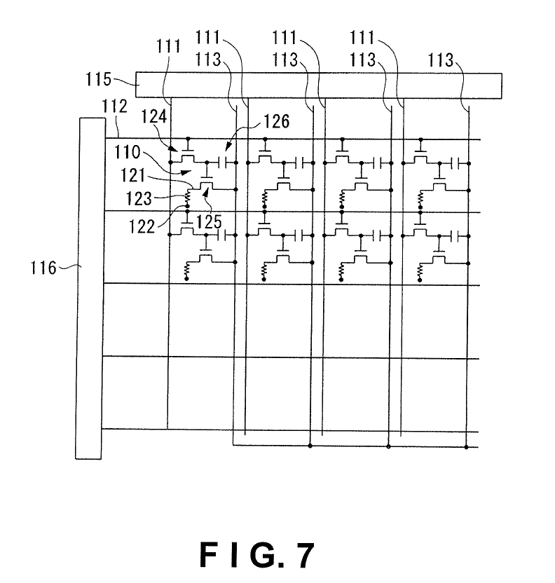

As shown in FIGS. 6 and 7, an actual display region 114 in which a plurality of pixel regions 110, data lines 111, scan lines 112, and power supply lines 113 are provided is formed in the center portion of the element substrate 101.

Pixel regions 110 of the same color are arranged in the Y direction shown in FIG. 6, and R (red), G (green), and B (blue) pixel regions 110 repeat in sequence in the X direction. Specifically, the pixel regions 110 are arranged in stripes with pixel regions 110 of the same color arranged in straight lines in one direction (Y direction) being arranged in alternating fashion in the other direction (X direction).

A dummy region 117 in which data line drive circuits 115 and scan line drive circuits 116 are provided is formed on the outside of the actual display region 114 of the element substrate 101, as shown in FIG. 6. Cathode wiring 118 connected to a cathode layer 122 described hereinafter is provided outside the dummy region 117 of the element substrate 101. The actual display region 114 and the dummy region 117 form a pixel portion 119.

Each of the plurality of pixel regions 110 is provided with an anode layer 121 as a pixel electrode, a cathode layer 122, and a luminescent layer 123 that is held between the anode layer 121 and the cathode layer 122, as shown in FIG. 7. The anode layer 121, cathode layer 122, and luminescent layer 123 form an organic EL element. Each of the plurality of pixel regions 110 is provided with a storage capacitor 126, and TFT elements 124, 125 for switching and controlling the anode layer 121.

The gate of each TFT element 124 is connected to a scan line 112, the source is connected to a data line 111, and the drain is connected to a TFT element 125 and a storage capacitor 126. The TFT elements 124 are configured so as to feed to the storage capacitors 126 a data signal fed from the data line drive circuits 115 via the data lines 111 in accordance with a scan signal fed from the scan line drive circuits 116 via the scan lines 112.

The gate of each TFT element 125 is connected to the drain of a TFT element 124, the source is connected to a power supply line 113, and the drain is connected to an anode layer 121. The on/off state of each TFT element 125 is determined according to a data signal stored by the storage capacitor 126, and the TFT elements 125 are configured so as to feed to the anode layers 121 a drive current fed via the power supply lines 113.

The data lines 111, scan lines 112, and power supply lines 113 are arranged in a grid pattern in the actual display region 114. The data lines 111 are connected to the data line drive circuits 115, and the scan lines 112 are connected to the scan line drive circuits 116.

The structure of the pixel regions 110 in the element substrate 101 will next be described in detail.

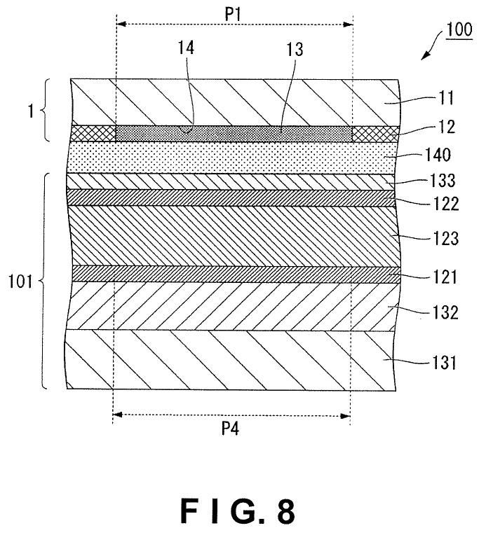

As shown in FIG. 8, the element substrate 101 is provided with a substrate main body 131 composed of glass or another translucent material, for example, and an element formation layer 132, the anode layer 121, the luminescent layer 123, the cathode layer 122, and a cathode protective film 133 that are layered on the substrate main body 131.

The data lines 111, scan lines 112, and power supply lines 113, and the TFT elements 124, 125 are formed via an appropriate insulation film on the element formation layer 132.

The anode layer 121 is formed using ITO (indium tin oxide) or another translucent conductive material, for example, and is connected to the drain of the TFT element 125.

The luminescent layer 123 is formed using various fluorescent substances, phosphorescent substances, and other luminescent substances such as low-molecular-weight organic luminescent dyes and polymer luminescent substances, e.g., Alg₃ (tris(8-quinolinol)aluminum) and the like. The luminescent layer 123 is formed so as to emit white light when a voltage is applied thereto. A positive hole injection layer, positive hole transport layer, electron transport layer, or the like may be formed as appropriate between the luminescent layer 123 and the anode layer 121, or between the luminescent layer 123 and the cathode layer 122.

The cathode layer 122 is composed of an LiF (lithium fluoride) film having a thickness of 1 nm, for example, and an Mg (magnesium)Ag (silver) film having a thickness of 10 nm, for example, layered in sequence from the luminescent layer 123. The cathode layer 122 forms a shared electrode extending through the plurality of pixel regions 110.

The cathode protective film 133 is formed using an inorganic compound such as silicon oxide, silicon nitride, silicon oxynitride, or another silicon compound, for example, and prevents the cathode layer 122 from corroding in the manufacturing process.

The color filter 1 is bonded to the top surface of the element substrate 101 by an adhesive layer 140. The color filter 1 is arranged to correspond to the pixel regions 110 so that the pitch P1 of the drawing regions 14 is an integer multiple of the pitch P4 of the pixel regions 110.

Through the color filter 1 and method for manufacturing the color filter 1 according to the present embodiment as described above, by ejecting the liquid to the ejection regions 15 without any change in the pattern of ejection by the plurality of nozzles N, it is possible to suppress fluctuation of amount of liquid ejected in the drawing regions 14. Consequently, the thickness of the color filter layers 13 in the drawing regions 14 can be made more uniform. By providing the adjustment regions 16 so as to be connected to the ejection regions 15, the pitch P1 of the drawing regions 14 can be coordinated with the pitch of the pixel regions 110. By forming the bank 12 of a light-shielding material, light can be prevented from leaking through the bank 12 from the pixel regions 110 of the organic EL device 100, and the contrast and other image quality aspects of the organic EL device 100 can be enhanced.

In the organic EL device 100 of the present embodiment, the image quality of the organic EL device 100 is enhanced by providing a color filter 1 that has color filter layers 13 of a more uniform thickness.

The present invention is not limited to the embodiments described above, and various modifications may be applied without departing from the scope of the present invention.

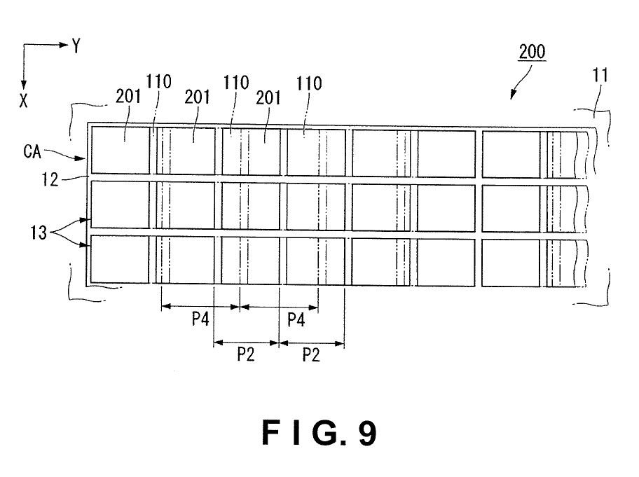

For example, the drawing regions may be formed by only the ejection regions, and not including adjustment regions, as shown in FIG. 9. In the color filter 200 shown in FIG. 9, drawing regions 201 formed by only ejection regions are arranged at a pitch P2 in the Y direction without regard to the pitch P4 of the pixel regions 110 of the element substrate 101.

The pitch of the ejection regions is three times the pitch of the nozzles, but the pitch of the ejection regions is not limited to three times the pitch of the nozzles, insofar as the pitch of the ejection regions is an integer multiple of the pitch of the nozzles. In the same manner, the pitch of the drawing regions is an integer multiple of the pitch of the pixel regions, but need not be an integer multiple.

The pitch of the drawing regions is an integer multiple of the pitch of the pixel regions, but this configuration is not limiting.

The bank may not necessarily be formed using a light-blocking material.

The nozzles are arranged in one row in the Y direction, but may be arranged at an angle to the Y direction insofar as the pitch of the ejection regions in the Y direction is an integer multiple of the pitch of the nozzles in the Y direction.

The color filter is manufactured by forming a plurality of panel regions on a mother substrate and dividing the mother substrate for each panel region, but the color filter may also be manufactured by forming only one panel region on the substrate.

The display device provided with the color filter is not limited to an organic EL device, and may be a liquid crystal display device or other display device insofar as the display device displays each color of color filter layer by transmission through the color filter.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for manufacturing a color filter comprising:
forming a bank on a substrate to partition the substrate into a plurality of drawing regions; and
forming color filter layers in the drawing regions by selectively moving a droplet ejection head having a plurality of nozzles in a first scanning direction and a second scanning direction relative to the substrate and selectively ejecting a liquid from the nozzles into each of the drawing regions,
the forming of the bank including partitioning the substrate into the drawing regions including a plurality of ejection regions, into which the liquid is ejected from the nozzles, with the ejection regions being arranged with a first prescribed pitch in the first scanning direction that is equal to an integer multiple of a pitch of the nozzles in the first scanning direction,
the forming of the color filter layers including ejecting the liquid from the same set of the nozzles before and after the droplet ejection head is moved relative to the substrate in the first scanning direction.

2. The method for manufacturing a color filter according to claim 1, wherein
the forming of the bank includes partitioning the substrate into the drawing regions including a plurality of adjustment regions that adjust a pitch of the drawing regions in the first scanning direction to a second prescribed pitch that is equal to an integer multiple of a pitch in the first scanning direction of pixel regions of a display device in which the color filter is used, each of the drawing regions being formed by at least one of the adjustment regions and at least one of the ejection regions that are connected together.

3. The method for manufacturing a color filter according to claim 1, wherein
the forming of the bank includes forming the bank with light-blocking material.

4. A color filter comprising:
a bank formed on a substrate and partitioning a plurality of drawing regions on the substrate; and
color filter layers formed by ejecting a liquid from a plurality of nozzles arranged in a row in a droplet ejection head into the drawing regions,
the drawing regions including a plurality of ejection regions, into which the liquid is ejected, with the ejection regions being arranged with a first prescribed pitch in a first direction that is equal to an integer multiple of a pitch of the nozzles in the first direction.

5. The color filter according to claim 4, wherein
the drawing regions include a plurality of adjustment regions that adjust a pitch of the drawing regions in the first direction to a second prescribed pitch, each of the drawing regions being formed by at least one of the adjustment regions and at least one of the ejection regions that are connected together.

6. A display device comprising the color filter according to claim 4.
